(19) United States
(12) Patent Application Publication
(10) Pub. No.: US 2026/0288259 A1
(43) Pub. Date: Sep. 24, 2026

(54) TOUCH-SENSITIVE SENSOR DEVICE FOR SENSING A POSITION OF AN OBJECT TOUCH

(71) Applicant: ams-OSRAM AG, Premstaetten (AT)

(72) Inventors: Pierre HILLERITEAU, Anglet (FR); Ho Hoai Duc NGUYEN, Karlsruhe-Neureut (DE); Guillaume LARIGNON, Gaillac (FR); Maarten PENNINGS, Waalre (NL); Sébastien RANDOUX, Paris (FR)

(21) Appl. No.: 19/474,188

(22) PCT Filed: Mar. 22, 2024
(86) PCT No.: PCT/EP2024/057797

§ 371 Date: Oct. 10, 2025

(30) Foreign Application Priority Data
Apr. 13, 2023 (DE) 10 2023 109 304.5

(51) Int. Cl. G06F 3/0354; G06F 3/042

(52) U.S. Cl. CPC G06F 3/03543; G06F 3/03547; G06F 3/0421

(57) ABSTRACT

A touch-sensitive sensor device for sensing a position of an object touch on the sensor device is provided. The touch-sensitive sensor device comprises a housing having a ceiling, a first distance sensor and a second distance sensor disposed spaced apart from each other in the housing. A light-reflective surface is disposed spaced apart from the first and second distance sensor. A processing circuit is configured to determine the position of the object touch on the ceiling by evaluating a detected first distance variation between the first distance sensor and the light reflective surface caused by the object touch, and a detected second distance variation between the second distance sensor and the light reflective surface caused by the object touch.

### CROSS-REFERENCE TO RELATED APPLICATIONS

This application is a 371 U.S. National Phase of PCT International Patent Application No. PCT/EP2024/057797 filed on Mar. 22, 2024, which claims priority from German Patent Application No. 102023109304.5 dated Apr. 13, 2023, the disclosures of which are incorporated by reference herein in their entirety for all purposes.

### TECHNICAL FIELD

The disclosure relates to a touch-sensitive sensor device responding to an object tap on a surface of the sensor device or the sliding of the object over the surface of the sensor device. The disclosure further relates to a slide controller device for controlling an apparatus by sliding an object over a surface of the controller device.

### BACKGROUND

A touch-sensitive sensor device for sensing a position, for example a touch slider sensor device, is operated by sliding/moving an object over a surface of the sensor. A typical conventional touch slider sensor device is based on capacitive touch sensing. A capacitive touch slider sensor device usually comprises an array of a plurality of plates, foils, elements or metallic meshes, each of these forms a capacitor and needs to be sensed individually to detect an object swipe over the array. When an object comes in contact with one of the capacitive plates, the capacitance of that plate changes. The change of capacitance can be evaluated by a controller which converts the measured capacitances of all cells into a position of the touching object on the capacitive sensor elements.

A capacitive touch slider sensor device has some serious disadvantages. In particular, the sensor does not work very reliably when the touch-sensitive area of the sensor device is touched with wet fingers or gloves. Moreover, a capacitive touch slider sensor device allows only digital sensing with discrete positions based on the available capacitive plates of the sensor array. In conclusion, the precision/resolution of a capacitive touch slider device depends on the number of capacitive plates. A capacitive touch slider allows to detect discrete positions of a touch-event, but does not allow high-resolution location determination.

It would be welcome in the art to provide a touch-sensitive sensor device which allows high-resolution location determination of a tap or a movement of a touching object along a surface of the touch-sensitive sensor device.

### SUMMARY

A touch-sensitive sensor device that enables high-resolution determination of a current position of a touching object on a surface of the sensor device is provided.

The proposed approach of a touch-sensitive sensor device comprises a housing having a ceiling, a first distance sensor, a second distance sensor, a light-reflective surface and a processing circuit. The first distance sensor and the second distance sensor are arranged spaced apart from each other in the housing. The light-reflective surface is arranged spaced apart from the first and second distance sensor. The processing circuit is configured for determining the position of the object touch on the ceiling by evaluating a detected first distance variation between the first distance sensor and the light reflective surface caused by the object touch, and a detected second distance variation between the second distance sensor and the light reflective surface caused by the object touch. The detected first distance variation is based on a measurement of the first distance sensor and the detected second distance variation is based on a measurement of the second distance sensor.

When an object, for example an operator's finger or a touching device of a machine, is moved along the outer surface of the ceiling or an object tap, for example, a finger tap or a tap by a touching device of a machine, is exerted on the outer surface of the ceiling, the touch-sensitive sensor device enables determination of a position of the touching object on the ceiling with high-resolution.

The measurement carried out by means of the first and second distance sensor is based on the fact that when the object is moved along the outer surface of the touch-sensitive sensor device while touching the surface, a slight force or a slight contact pressure is exerted on the outer surface of the ceiling. This causes the distance between the light-reflective surface and the first and second distance sensor to be changed between a state, when no pressure is exerted on the ceiling, and a state, when a pressure is exerted on the ceiling. Since both of the first and second sensors are arranged in the housing spaced apart from each other, a different distance variation will be detected between the respective sensor and the light-reflective surface.

According to a possible embodiment of the touch-sensitive sensor device, the first distance sensor is configured for generating a first output signal, wherein a value of a signal amplitude of the first output signal represents the first distance variation, and the second distance sensor is configured for generating a second output signal, wherein a value of the signal amplitude of the second output signal represents the second distance variation. The values of the signal amplitudes of the first and second output signal or a combination/pair/tuple, for example, a ratio, of the values of the signal amplitudes of the first and second output signal of the distance sensors can then be used to determine the exact position of the touch-event.

The determination of the distance variation of the light-reflective surface to the first and second distance sensor enables a high-resolution determination of the instantaneous position of the touching object on the outer surface of the ceiling. The touch-sensitive sensor device is thus designed as a continuous touch slider. Since only two electrical components, namely the first distance sensor and the second distance sensor, are necessary for the high-resolution position determination of an object tapped on or moved along the outer surface of the ceiling, the touch-sensitive sensor device can be very thin.

According to a possible embodiment of the touch-sensitive sensor device, the ceiling is configured as the light reflective surface. In this case, the first and second distance sensors may be placed on a carrier board being arranged in a distance below the light-reflective ceiling.

The touch-sensitive sensor device may comprise a ground floor/plate being arranged spaced apart from the first and second distance sensor. The first and second distance sensor may be placed on the underside of the ceiling facing the ground floor or on a carrier board being mounted to the underside of the ceiling. According to this setup, the ground floor is embodied as the light-reflective surface.

According to a possible embodiment of the touch-sensitive sensor device, the first distance sensor is embodied as a first optical force sensor which comprises a first light emitter and a first light receiver. The second distance sensor is embodied as a second optical force sensor which comprises a second light emitter and a second light receiver. The first light receiver is arranged close to the first light emitter on the carrier board so that the light emitted by the first light emitter and reflected by the light-reflective surface is essentially detected by the first light receiver, and not or only to a small extend by the second light receiver. The second light receiver is positioned close to the second light emitter on the carrier board so that the light emitted by the second light emitter and reflected by the ceiling is essentially detected by the second light receiver, and not or only to a small extent by the first light receiver.

The first light emitter is configured to emit first light beams towards the light-reflective surface. The second light emitter is configured to emit second light beams towards the light reflective surface. Since both of the first and second light emitters are positioned on the carrier board at different positions, the emitted light of the first light emitter hits the light-reflective surface at a different position than the second light beams emitted by the second light emitter.

The light-reflective surface is configured to reflect a portion of the first light beams towards the first light receiver. Furthermore, the light-reflective surface is configured to reflect a portion of the second light beams towards the second light receiver. The light-reflective surface thus reflects the light emitted by the first light emitter to a first position of the light-reflective surface towards the first light receiver. The light emitted by the second light emitter which hits the light-reflective surface at a second position is reflected towards the second light receiver.

According to a possible embodiment of the touch-sensitive sensor device, the first light receiver is configured to provide the first output signal in response to the portion of the first light beams received by the first light receiver. The first light receiver is configured to provide the first output signal in dependence on an intensity of the portion of the first light beams received by the first light receiver. The second light receiver is configured to provide the second output signal in response to the portion of the second light beams received by the second light receiver. The second light receiver is configured to provide the second output signal in dependence on an intensity of the portion of the second light beams received by the second light receiver.

Since the first light receiver is positioned closer to the first light emitter than to the second light emitter, the first light receiver provides the first output signal essentially in dependence on the reflected portion of the first light beams. On the other hand, since the second light receiver is positioned on the carrier board closer to the second light receiver, the second output signal is provided by the second light receiver essentially in dependence on the reflected portion of the second light beams.

The light intensity of the reflected light received by the light receivers of the different optical force sensors depends on how far the ceiling has been pressed down by the contact pressure of the touching object and how close the area of the ceiling that has been pressed down is to the respective optical force sensor. For example, if the depressed area of the ceiling is closer to the first optical force sensor than to the second optical force sensor, the first light receiver may detect a higher intensity of the reflected light than the second light receiver. Conversely, if the depressed area of the ceiling is closer to the second optical force sensor than to the first optical force sensor, the second light receiver may detect a higher intensity of the reflected light than the first light receiver.

According to a possible embodiment of the touch-sensitive sensor device, the ceiling has an area that is flexible such that the distance between the first and second distance sensor and the light-reflective surface is changed by applying a pressure of an object onto the area of the ceiling. The surface hardness of the material of the area of the ceiling along which the touching object is moved is optimized to be deflected with respect to the carrier board or the ground floor, if a pressure is exerted onto the outer surface of the ceiling by the touching object.

According to a possible embodiment of the touch-sensitive sensor device, the ceiling may have an area having a flat surface or a curved surface. The area of the ceiling having the flat or curved surface is the region of the ceiling along which the touching object is moved.

According to a possible embodiment of the touch-sensitive sensor device, the light-reflective surface has a material that is reflective for the first light beams emitted by the first light emitter of the first optical force sensor and the second light beams emitted by the second light emitter of the second optical force sensor. In particular, the first and second light emitters may be configured to emit IR (infrared) light or blue light. In this case, the material of the light-reflective surface is reflective for light beams of IR light or blue light.

The touch-sensitive sensor device may further be configured such that the ceiling has a material that is opaque for a respective wavelength of the light the first and second light receivers are sensitive to receive. This embodiment prevents light having the sensitive wavelength and coming from the outside from entering the cavity between the first and second distance sensors and the light-reflective surface, and thus interfering with the light beams reflected at the light-reflective surface.

For correct detection of the light intensities of the reflected light, it would be desirable, if the light emitted by the first light emitter and reflected at the light-reflective surface is received by the first light receiver, and the light emitted by the second light emitter and reflected at the light-reflective surface is received by the second light receiver.

For this purpose, according to a first possible embodiment of the touch-sensitive sensor device, the first light emitter is configured to emit the first light beams with a first wavelength. The second light emitter is configured to emit the second light beams with a second wavelength that is different from the first wavelength. The first and second light receivers are sensitive for different wavelengths, in particular the first light receiver is sensitive to the first wavelength of the first light beams, and the second light receiver is sensitive to the second wavelength of the second light beams.

According to another possible embodiment of the touch-sensitive sensor device, the first light emitter is embodied to emit the first light beams as pulsed first light beams, and the second light emitter is embodied to emit the second light beams as pulsed second light beams. The first pulsed light beams and the second pulsed light beams are emitted alternately. When the first and second light receivers are also activated alternately, the first light receiver can receive the pulsed first light beams and the second light receiver can receive the second pulsed light beams. The first and second optical force sensor are thus operated by a time-multiplexed pulse scheme which enables the first reflected light beams to be received by the first light receiver and the second reflected light beams to be received by the second light receiver.

According to a possible embodiment of the touch-sensitive sensor device, the processing circuit is configured to determine a position of a pressure exerted on the outer surface of the ceiling facing away from the cavity in dependence on the value of the signal amplitude of the first output signal, and a value of the signal amplitude of the second output signal. The value of the signal amplitude of the first output signal represents a detected distance variation between the first distance sensor and the light-reflective surface, the distance variation being caused by applying a force on the ceiling. The value of the signal amplitude of the second output signal represents a detected distance variation between the second distance sensor and the light-reflective surface, the distance variation caused by applying the force on the ceiling. A combination, for example, a ratio, of the value of the signal amplitude of the first output signal and the value of the signal amplitude of the second output signal may be used to calculate the position of a touch-event by using a mathematical function.

For example, by using the ratio of the value of the signal amplitude of the first output signal and the value of the signal amplitude of the second output signal, the position of a touch-event on the outer surface of the ceiling can be determined independently on the force applied by a user on the outer surface of the ceiling. It has been found by the inventors that the position of the touch-event along an axis defined between the distance sensors is a function of the ratio between the respective values of the signal amplitudes of the first and second output signal or the ratio between the variations of the distances between the sensors and the light-reflective surface. The relationship between the ratios of the values of the signal amplitudes of the first and second output signals and the positions of the touch-events can be approximated, for example, with a polynomial function, particularly a polynomial function of order 5.

The proposed approach allows to track the position of a contact between a touching object, for example, a user's finger or a touching device of a machine, and a smart surface of the touch slider sensor device in real time, i.e., the position of a touch on the surface of the ceiling of the touch slider sensor device is computed while the touch-event is still ongoing, for example, an object is still touching the surface. The position of the touch-event is determined by means of the function after having done a fitting. In particular, the polynomial approach provides a performant way to compute the position in real time with low computational and memory requirements. Moreover, as explained above, this approach is independent from the force applied by the user on the surface.

According to a possible embodiment of the touch-sensitive sensor device, the processing circuit is configured for determining a smoothed position by applying median and/or average filtering to a plurality of positions determined at subsequent times. The smoothing allows to remove a jitter and to provide a stable output.

According to a possible embodiment of the touch-sensitive sensor device, the processing circuit is configured to assess the determined position as being valid by calculating a derivative of the first and second output signal and evaluating the derivative with respect to a threshold value.

A slide controller device for controlling an electronic apparatus is provided.

The slide controller device comprises a touch-sensitive sensor device according to an embodiment as described above. The slide controller device has an outer surface. According to a first possible embodiment, the outer surface is configured as the ceiling of the touch-sensitive sensor device. According to a second possible embodiment, the outer surface is mechanically coupled to the ceiling of the touch-sensitive sensor device so that a distance between the light-reflective surface and the first and second distance sensor is changed while applying a force onto the outer surface of the controller device.

Additional features and advantages of the touch-sensitive sensor device and the slide controller device are set forth in the detailed description that follows. It is to be understood that both the foregoing general description and the following detailed description are merely exemplary, and are intended to provide an overview or framework for understanding the nature and character of the claims.

### BRIEF DESCRIPTION OF THE DRAWINGS

The accompanying drawings are included to provide further understanding, and are incorporated in, and constitute a part of, the specification. As such, the disclosure will be more fully understood from the following detailed description, taken in conjunction with the accompanying figures in which:

FIG. 1 shows an embodiment of a touch-sensitive sensor device for monitoring of the movement of a touching object along a ceiling of the sensor device and high-resolution detection of a position of the touching object on the ceiling;

FIG. 2 illustrates a measurement principle used by an optical force sensor to detect the application of a contact pressure on a flexible ceiling above the optical force sensor;

FIG. 3 shows a possible application of a touch-sensitive sensor device in a slide controller device for monitoring of the movement of a touching object along an outer surface of the slide controller device and high-resolution determination of a position of the touching object on the outer surface of the slide controller device;

FIG. 4 illustrates a workflow of a real-time algorithm for estimation of a position of a touch-event;

FIG. 5 illustrates a portion of the workflow of the real-time algorithm to detect a consolidated event status;

FIG. 6 illustrates the workflow of the real-time position module of the real-time algorithm; and

FIG. 7 illustrates synchronized/non-synchronized signal amplitudes of output signals provided by the optical force sensors.

### DETAILED DESCRIPTION

Slide controller devices are used in many applications to control and set operating parameters of an apparatus. Such slide controller devices are used, for example, to dim a lighting system or to set a temperature of a heating system. In the case of mechanical slide controller devices, a slider is moved in a carriage by hand for this purpose. With touch-sensitive slide controller devices, it is no longer necessary to move a slide button mechanically. The control or adjustment of an operating parameter of an apparatus is done by an operator/machine sliding his finger/touching device over a touch-sensitive surface. The position of the finger/touching device on the touch-sensitive surface is detected by a sensor of the slide controller device. The parameters to be controlled can be set depending on the position of the touching object on the touch-sensitive surface of the slide controller device.

Capacitive elements, for example, can be used as sensor cells for touch-sensitive slide controller devices. The touch-sensitive surface is designed as a capacitive sensor field. When the touching object is moved along the touch-sensitive surface, the capacitance of the capacitive elements changes, when they are touched by the touching object. This allows the position of the touching object on the touch-sensitive surface to be detected.

However, the precision/local resolution of a slide controller device using capacitive elements depends on the number of capacitive elements so that a capacitive slide controller device often only allows digital sensing with discrete positions of touching object moved over the touch-sensitive surface.

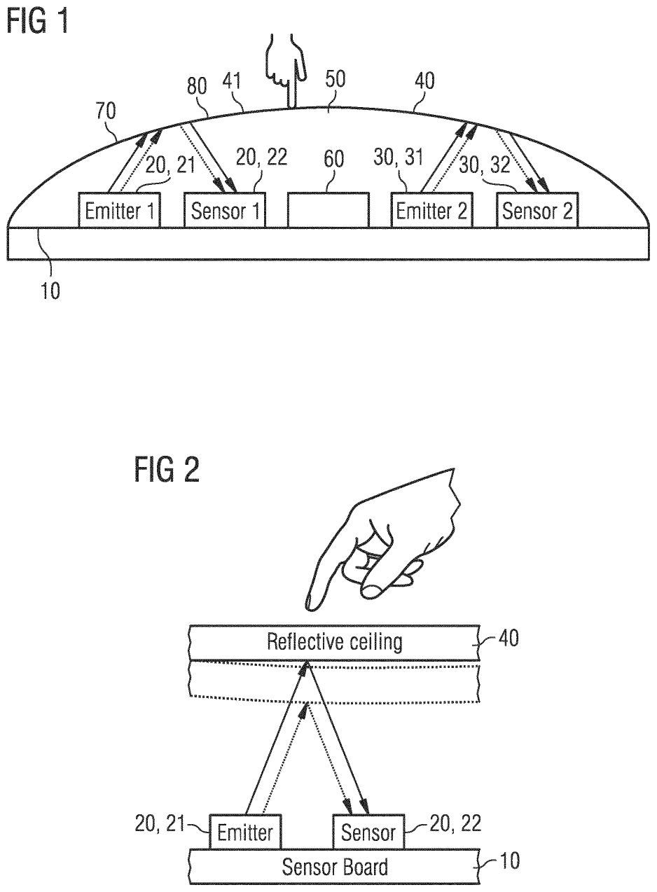

FIG. 1 shows another approach of a touch-sensitive sensor device 1 which can be used in a slide controller device for monitoring a continuous movement of a touching object along a touch-sensitive surface and which allows the determination of a current position of the touching object on the touch-sensitive surface with high precision and thus with high resolution.

Referring to FIG. 1, the touch-sensitive sensor device 1 comprises a housing 70 having a ceiling 40, a first distance sensor 20 and a second distance sensor 30. The first distance sensor 20 and the second distance sensor 30 are arranged spaced apart from each other in the housing 70. FIG. 1 shows the first and second distance sensor 20, 30 arranged spaced apart from each other on a carrier board 10. The embodiment is not limited to the shown two distance sensors 20, 30 and may also contain more than the two sensors. The touch-sensitive sensor device 1 further comprises a light-reflective surface 80 being arranged spaced apart from the first and second distance sensor 20, 30.

The touch-sensitive sensor device 1 comprises a processing circuit 60 for determining a position of an object touch on the ceiling 40. The processing circuit 60 is configured to determine the position of the object touch by evaluating a detected first distance variation between the first distance sensor 20 and the light-reflective surface 80 caused by the object touch, and a detected second distance variation between the second distance sensor 30 and the light reflective surface 80 caused by the object touch. The detected first distance variation is based on a measurement of the first distance sensor, and the detected second distance variation is based on a measurement of the second distance sensor.

The first distance variation is the difference of a first distance between the first distance sensor 20 and the light-reflective surface 80 at rest, i.e., when no force is applied on the ceiling 40, and a second distance between the first distance sensor 20 and the light-reflective surface 80, when a force, for example, a finger touch or a touch of a touching device of a machine, is exerted to the ceiling 40 and the ceiling 40 is thus deformed.

The second distance variation is the difference of a third distance between the second distance sensor 30 and the light-reflective surface 80 at rest, i.e., when no force is applied on the ceiling 40, and a fourth distance between the second distance sensor 30 and the light-reflective surface 80, when a force, for example, a finger touch or a touch of a touching device of a machine, is exerted to the ceiling 40 and the ceiling 40 is thus deformed.

The first distance sensor 20 may be configured for generating a first output signal. A value A₁ of a signal amplitude of the first output signal represents the first distance variation. The first distance sensor 20 may be configured to output the value A₁ of the signal amplitude of the first output signal. Alternatively, the first distance sensor 20 is configured to output a raw output signal, and the output signal may be processed, for example, by processing circuit 60, to obtain the value A₁. The second distance sensor 30 may configured for generating a second output signal. A value A₂ of a signal amplitude of the second output signal represents the second distance variation. The second distance sensor 30 may be configured to output the value A₂ of the signal amplitude of the second output signal. Alternatively, the second distance sensor 30 is configured to output a raw output signal, and the output signal may be processed, for example by processing circuit 60, to obtain the value A₂.

A combination/pair/tuple, for example, a ratio, of the value A₁ of the signal amplitude of the first output signal and the value A₂ of the signal amplitude of the second output signal may be used by the processing circuit 60 to calculate the position of a touch-event by using a mathematical function. An embodiment of an algorithm that can be used by the processing circuit 60 to determine the position of a touch-event on the ceiling 40 is explained below.

Referring to the embodiment of the touch-sensitive sensor device 1 shown in FIG. 1, the ceiling 40 is configured as the light-reflective surface. The first and second distance sensor 20 and 30 are arranged on a carrier board 10 spaced apart from the ceiling 40. When a pressure is exerted on the ceiling 40, the distance between each of the first and second distance sensors 20, 30 and the ceiling 40 is changed. The respective distance variation between each of the first and second distance sensors 20, 30 and the ceiling 40 is detected and used by the processing circuit 60 for determining the position of the object touch.

According to another possible embodiment of the touch-sensitive sensor device, the first and second distance sensor 20, 30 are mounted to the ceiling or a carrier board on which the first and second distance sensor 20, 30 are placed is mounted to the ceiling 40. In this embodiment, a ground floor/plate located below the ceiling and spaced apart from the first and second distance sensor 20, 30 is configured as the light-reflective surface 80. When a pressure is exerted on the ceiling 40 by a touch-event, the distance between the ceiling 40 or the first and second distance sensor 20, 30 and the ground floor/plate is changed. The first distance variation between the first distance sensor 20 and the ground floor/plate as well as the second distance variation between the second distance sensor 30 and the ground floor/plate is evaluated by the processing circuit 60 to determine the position of the touch-event on the ceiling 40.

Several realizations for the first and second distance sensor 20, 30 are possible. For example, the first and second distance sensor can respectively embodied as an optical force sensor, a TOF (Time-Of-Flight)-sensor, an SMI (Self-Mixing-Interferometry)-sensor, etc. In the following, an embodiment of the touch-sensitive sensor device, where the first and second distance sensors are respectively embodied as an optical force sensor, and where the ceiling 40 is configured as the light-reflective surface 80 is described with reference to FIG. 1.

FIG. 1 shows a first optical force sensor 20 and a second optical force sensor 30 arranged spaced apart from each other on the carrier board 10. The first and second optical force sensor 10, 20 can, for example, be arranged at a distance of 8 cm to 12 cm from each other on the carrier board 10.

The touch slider sensor device 1 further comprises a light-reflective ceiling 40 being arranged, in the cross-sectional view of FIG. 1, spaced apart above the first and second optical force sensor 20, 30. Thus, a cavity 50 is formed between the carrier board 10 or the first and second optical force sensor 30 and the light-reflective ceiling 40. The light-reflective ceiling 40 is, for example, arranged at a distance of 3 mm to 10 mm above the first and second optical force sensor 20, 30.

FIG. 2 illustrates the measurement principle of a single optical force sensor 20 for detecting a contact pressure exerted on a surface of a ceiling 40 arranged above the optical force sensor. A light emitter 21 of the optical force sensor 20 emits light towards the ceiling 40. The light is reflected at the ceiling 40 back towards a light receiver 22 of the optical force sensor. The intensity of the reflected light can be detected by the light receiver 22.

Provided that the material of the ceiling 40 has a certain hardness/flexibility, it will bend slightly downwards due to object pressure, as illustrated in FIG. 2. Since the distance between the optical force sensor 20 and the ceiling 40 is reduced, the intensity of the reflected light received by the light receiver 22 is changed.

In conclusion, the optical force sensor 20 detects a changed intensity of the reflected light when object pressure is applied to the outer surface of the ceiling 40 and the ceiling moves slightly downwards towards the optical force sensor compared to when no force is applied to the ceiling. By measuring the intensity variation of the light received by the optical force sensor at rest, i.e., before the touch-event, and at the touch-event, it is thus possible to determine whether a force has been applied to the ceiling.

Referring again to FIG. 1, the light reflective ceiling 40 has an area/touch-sensitive surface 41 which is flexible to the extent that a slight contact force, which occurs when a touching object slides over the surface/area 41, allows the ceiling 40 to be moved with respect to the carrier board 10 and thus with respect to the first and second optical force sensors 20, 30. The first and second optical force sensor 20, 30 respectively emit light towards the light-reflective ceiling 40. The respective light rays illustrated by the arrows in FIG. 1 are reflected back at the light-reflective ceiling 40 towards the first optical force sensor 20 and the second optical force sensor 30. Each of the first and second optical force sensor 20, 30 is configured to measure the respective intensity of the received, previously reflected light.

As explained above with reference to FIG. 2, the intensity of the light reflected at the light-reflective ceiling 40 changes, as the ceiling 40 is deformed, when a touching object slides along an outer surface of the light-reflective ceiling and exerts a contact pressure. Depending on where the touching object is currently located on the outer surface of the light-reflective ceiling 40, the first optical force sensor 20 and the second optical force sensor 30 detect a changed intensity, for example a higher intensity, of the reflected light.

According to the proposed approach of the touch-sensitive sensor device 1, the respective intensity changes/variations of the reflected light received by first optical force sensor 20 and second optical force sensor 30 is determined. The detected changes/variations of the intensities allow processing circuit 60 to determine the exact position at which contact pressure has just been exerted on the surface of the light-reflective ceiling 40 when a touching object is moving along the outer surface of the ceiling 40.

The proposed approach of the touch-sensitive sensor device 1 thus allows a continuous and precise determination of a current position of a touching object which slides along the outer surface of the ceiling 40 or exerts a pressure on the outer surface of the ceiling by using only two sensors, i.e., first optical force sensor 20 and second optical force sensor 30, located inside the cavity 50 or the housing 70 of the touch-sensitive sensor device 1.

The first optical force sensor 20 comprises a first light emitter 21 and a first light receiver 22. The second optical force sensor 30 comprises a second light emitter 31 and a second light receiver 32. The first light emitter 21 is configured to emit first light beams towards the light-reflective ceiling 40. The second light emitter 31 is configured to emit second light beams towards the light-reflective ceiling 40.

The light-reflective ceiling 40 may have a material or a layer or a paint that is reflective for the first light beams emitted by the first light emitter 21 and for the second light beams emitted by the second light emitter 31. According to a possible embodiment of the touch-sensitive sensor device, each of the first and second light emitters 21, 31 may be configured to emit IR (infrared) light or other electromagnetic radiation towards the light-reflective ceiling 40. The light-reflective ceiling 40 may have a material or a layer or a paint that is reflective for IR light.

The light-reflective ceiling 40 is configured to reflect a portion of the first light beams towards the first receiver 22. Furthermore, the light-reflective ceiling 40 is configured to reflect a portion of the second light beams towards the second light receiver 32.

The first light receiver 22 is placed on the carrier board 10 close to the first light emitter 21 so that the first light receiver 22 mainly receives the reflected light that is emitted by the first light emitter 21. The second light receiver 32 is placed on the carrier board 10 close to the second light emitter 31 so that the second light receiver 32 mainly receives the reflected light which is emitted by the first light emitter 31.

To ensure that only the light emitted by the light emitters 21, 31 and reflected by the ceiling 40 is actually received by the light receivers 22, 32 to be evaluated later, the light-reflective ceiling 40 may have a material that is opaque for a respective wavelength of the light the first and second light receivers 22, 32 are sensitive to receive. This prevents light from the outside having a wavelength to which the receivers 22, 32 are sensitive from entering the cavity 50 through the light-reflective ceiling 40 and, in addition to the light reflected by the ceiling 40, falling on a light-sensitive area of the first and second light receiver 22, 32 and distorting the measurement.

According to a possible embodiment of the touch-sensitive sensor device 1, the first light receiver 22 is configured to provide a first output signal in response to the portion of the first light beams received by the first light receiver 31. In particular, the first light receiver 22 may be configured to provide the first output signal in dependence on an intensity of the portion of the first light beams received by the first light receiver 22. The second light receiver 32 may be configured to provide a second output signal in response to the portion of the second light beams received by the second light receiver 32. In particular, the second light receiver 32 may be configured to provide the second output signal in dependence on an intensity of the portion of the second light beams received by the second light receiver 32.

The touch-sensitive area/surface 41 of the light-reflective ceiling 40 may have a curved surface, as illustrated in FIG. 1. The touch slider sensor device is, however, not limited to a configuration with a curved surface of the light-reflective ceiling 40. According to another possible embodiment, the touch-sensitive area/surface 41 of the light-reflective ceiling 40 may have a flat surface.

Due to the distance of the first and second optical force sensor 20, 30 from each other on the carrier board 10, the first light receiver 22 mainly receives the reflected first light beams emitted by the first light emitter 21, and the second light receiver 32 receives the reflected second light beams emitted by the second light emitter 31. In order to avoid possible interference, i.e., so that the first light receiver 22 only receives the light emitted by the first light emitter 21, and the second light receiver 32 only receives the light emitted by the second light emitter 31, both of the first and second light emitter 21, 31 can emit light with different wavelengths. In particular, the first light emitter 21 is configured to emit the first light beams with a first wavelength, e.g., a wavelength of 850 nm, and the second light emitter 31 is configured to emit the second light beams with a second wavelength, e.g., a wavelength of 940 nm, being different from the first wavelength.

According to another possible embodiment, in order to avoid possible interference when receiving light by the first and second light receivers 22, 32, each of the first and second light beams may be emitted by the respective first and second light emitters 21, 31 as pulsed light beams. This means that the first light emitter 21 emits first pulsed light beams, and the second light emitter 31 emits second pulsed light beams, wherein the first pulsed light beams and the second pulsed light beams are emitted alternately at different moments. Assuming that the first and second light receivers 22, 32 are also activated alternately to receive the reflected first and second light beams, it can be ensured that the reflected first light beams are received by the first light receiver 22, and the second reflected light beams are received by the second light receiver 32.

According to another possible embodiment, a light separation device may be placed between the first and second optical force sensors 20, 30. The light separation device may be embodied as a wall that does not reach the ceiling 40 and/or a wall of soft foam.

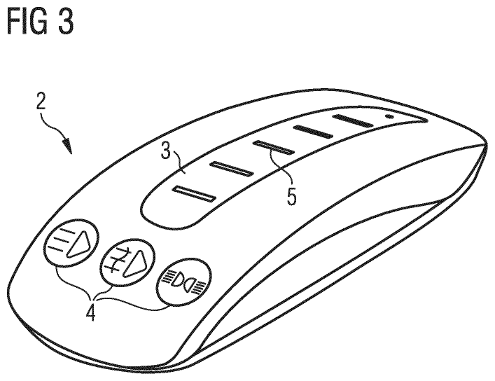

FIG. 3 shows a possible application of the touch-sensitive sensor device 1 in a slide controller device 2 for controlling an apparatus, for example, an electronic apparatus. The slide controller device 2 has an outer touch-sensitive surface 3. The touch-sensitive surface 3 may be embodied as the ceiling 40 of the touch-sensitive sensor device 1. According to another possible embodiment, the touch-sensitive surface 3 may be mechanically coupled to the ceiling 40 of the touch-sensitive sensor device 1. The ceiling 40 is deformed by sliding a touching object over the touch-sensitive surface 3 of the controller device 2 while applying a force onto the touch-sensitive surface 3 of the controller device 2 so that a distance between the light-reflective surface, and the first and second distance sensor 20, 30 is changed.

The slide controller device 2 can, for example, be designed for the stepless adjustment of an illumination intensity of a lighting device. Regarding the exemplified slide controller device 2 shown in FIG. 3, buttons 4 are provided to select different light sources whose brightness can be adjusted by sliding a touching object, for example, a finger or a touching device of a machine, over the touch-sensitive surface 3. Other applications of the slide controller device 2 are, for example, a stepless adjustment of a temperature of a heating system or, for example, the application as a computer mouse, etc. Regarding the application in a computer mouse, the touch slider sensor device 1 can enable a scroll bar of a computer to be moved by sliding an operator's finger over the touch-sensitive surface 3 of the mouse instead of moving a mechanical scroll wheel mounted to the mouse. The arrangement of two orthogonally arranged touch-sensitive sensor devices allow to realize a track pad.

According to a possible embodiment, the slide controller device 2 may be configured to display the detected instantaneous position of a touching object as the touching object swipes across the touch-sensitive outer surface 3 of the slide controller device. In the embodiment shown in FIG. 3, for example, light elements 5 for feedback, such as light-emitting diodes, can be embodied in the touch-sensitive outer surface 3 of the slide controller device 2 for this purpose. When a touching object is moved along the touch-sensitive outer surface 3 of the controller device, the light elements 5 light up and thus show the user the recognized position and the corresponding setting made. The slide controller device thus provides a direct force touch feedback to the user.

As explained above, although a particular advantage of the touch-sensitive sensor device 1 is the ability to detect positions of a touching object as it moves across the ceiling 40, the touch-sensitive sensor device 1 can also be used to detect discrete positions on the ceiling 40, when these positions are touched with the touching object. This makes it possible to implement a variety of virtual buttons on the touch-sensitive outer surface 3 with only two optical force sensors of the touch-sensitive sensor device.

An algorithm for determining the position of a touching object on the ceiling 40 is explained in detail below. For simplicity, the following describes the determination of the X-position X_{POS} on a grade along which a touching object moves.

The algorithm is based on the inventors' finding that the ratio of the value A₁ of the signal amplitude of the output signal of the first light receiver 22 and the value A₂ of the signal amplitude of the output signal of the second light receiver 32 is independent of the contact pressure or force with which the ceiling 40 is pressed down when contacted by the touching object.

The value A₁ of the signal amplitude of the output signal of the first light receiver 22 represents the difference between the measurement of the first distance sensor 20 when the ceiling 40 is deflected and an average of the sensor measurement when the ceiling is at rest, i.e., before it is deflected. The value A₁ thus represents the variation of the detected distance between the light-reflective surface 80 and the first distance sensor 20 when a pressure is exerted on the ceiling 40 and the detected distance when no touch event takes place.

The value A₂ of the signal amplitude of the output signal of the second light receiver 32 represents the difference between the measurement of the second distance sensor 30 when the ceiling 40 is deflected and an average of the sensor measurement when the ceiling is at rest, i.e., before it is deflected. The value A₂ thus represents the variation of the detected distance between the light-reflective surface 80 and the second distance sensor 30 when a pressure is exerted on the ceiling 40 and the detected distance when no touch event takes place.

The inventors found that the position of a touch-event is a function of the values A₁, A₂, . . . of the different signal amplitudes of the output signals of the distance sensors:

$${X}_{P o s} = f ( {A}_{1} , {A}_{2} , … )$$

If only two distance sensors are used, the function can be simplified to:

$${X}_{P o s} = f ( {A}_{1} , {A}_{2} )$$

In this case X_{POS} is the position of a touch-event along an axis defined by the first distance sensor 20 and the second distance sensor 30.

As a possible approach, the function could be well approximated with a polynomial, particularly a polynomial of order five, on a well defined sliding zone by using polynomial regression. On the other hand, this means that a position of a touch-event can be determined by means of a polynomial function using the values A₁, A₂ of the signal amplitudes of the first and second output signal as input parameters. The function for determining the position of the touch-event is not limited to the above-mentioned polynomial function. The use of other functions is also possible.

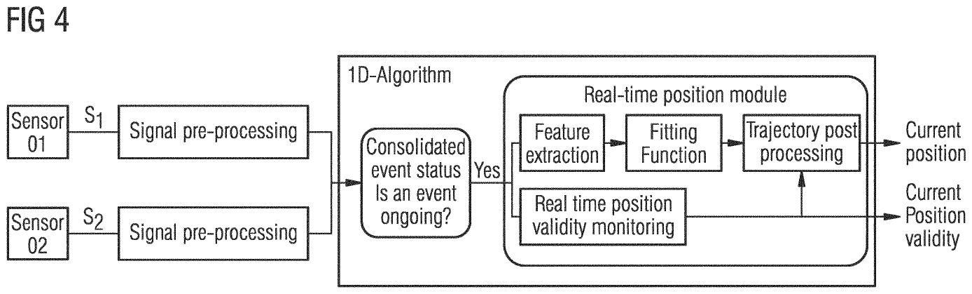

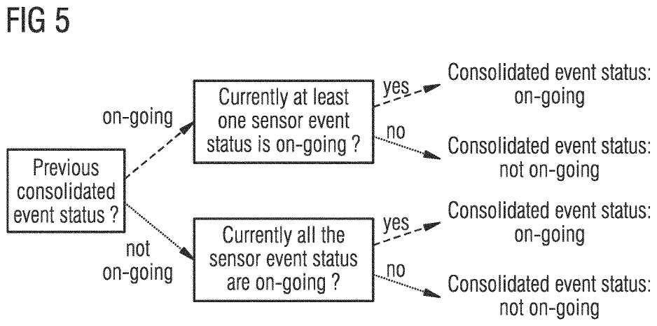

FIG. 4 illustrates the algorithm which allows the determination or estimation of the position of a force applied on a surface of the ceiling 40, for example, by a pressure of a touching device of a machine or a finger pressure, by measuring the surface deflection at several positions. The processing steps of the algorithm may be implemented in a storage unit of the processing circuit 60 to be applied by the processing circuit 60 for determining the position of the touching object on the surface of the ceiling by evaluating the output signals of the first distance sensor 20 and the second distance sensor 30.

According to a possible embodiment, the output of each of the first and second distance sensors 20 and 30 may be coupled to a respective ‘signal pre-processing’ module. The respective (raw) output signals of the first distance sensor 20, for example a first optical force sensor, and the second distance sensor 30, for example, a second optical force sensor, are used as input parameters for a respective ‘signal pre-processing’ module. Each ‘signal pre-processing’ module monitors the output signal provided by the respective one of the distance sensors coupled to the respective ‘signal pre-processing’ module.

The ‘signal pre-processing module’ coupled to the first distance sensor 20 detects the event/occurrence of the signal amplitude outputted by the first distance sensor 20 and provides the value A₁ of the signal amplitude of the output signal of the first optical force sensor 20 as output signal.

The ‘signal pre-processing’ module coupled to the second optical force sensor 30 detects the event/occurrence of the signal amplitude outputted by the second distance sensor 30 and provides the value A₂ of the signal amplitude of the output signal of the second optical force sensor 30 as output signal. The occurrence of the signal amplitudes in the respective output signal of the first and second optical force sensor 20, 30 indicates a pressure being applied to the ceiling 40.

The output of the ‘signal pre-processing’ modules, especially the detected values A₁, A₂ of the signal amplitudes of the output signals of the first and second optical force sensor 20, 30, are transferred to and further processed by a ‘Consolidated event status’ module and a subsequent ‘Real-time position’ module. The ‘signal pre-processing’ modules can be omitted, when the first and second optical force sensors 20, 30 are configured to directly output the values A₁ and A₂.

The ‘Consolidated event status’ module evaluates the output of the ‘signal pre-processing’ module and indicates whether a touch-event is on-going or not. It is computed every time a new pair of sensor measurements/output signals is received. The output of the ‘Consolidated event status’ module is based on its previous state, and on the latest result/output of the ‘signal pre-processing’ modules. Based on the previous and the current consolidated event status, the algorithm can detect the start and the end of a consolidated event, as well as their timestamps. FIG. 5 illustrates the logic of the computation.

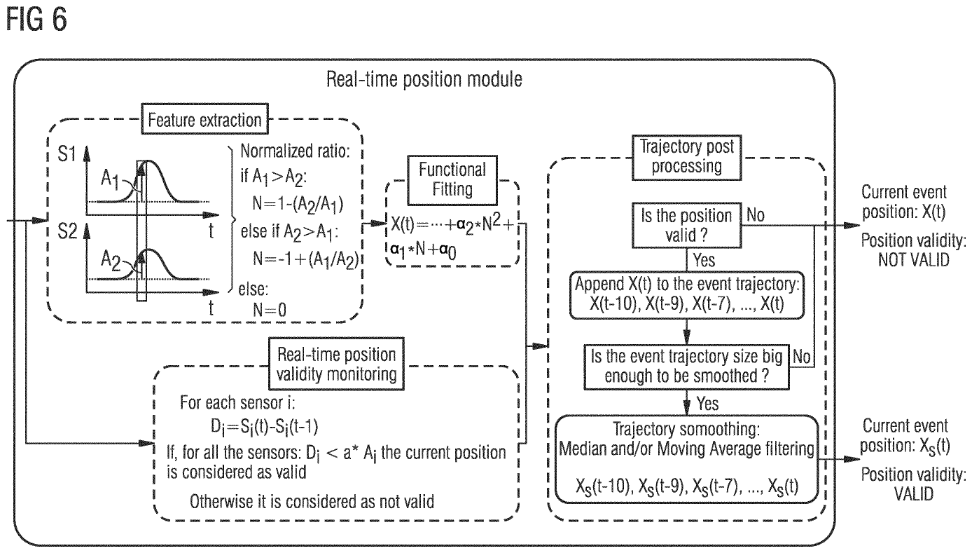

FIG. 6 shows the processing of the ‘Real time position’ module of the algorithm in detail. The ‘Real time position’ module receives the result of the ‘Consolidated event status’ module, i.e. a ‘yes’ or ‘no’ decision in terms of checking whether the event ‘object pressure’ is on-going or not. If it has been evaluated by the ‘Consolidated event status’ module that the event is ongoing, the ‘Real time position’ module computes the current position of the touching object on the surface. In particular, the ‘real time position’ module provides a smoothed current event position Xₛ(t) as output and sets a position validity flag ‘VALID’, if the current position is considered to be valid, or the current position is discarded, if the current position is considered as non valid.

The ‘Real time position’ module of the algorithm comprises several sub-modules, i.e., a ‘Feature extraction’ sub-module, a ‘Polynomial evaluation’ sub-module, a ‘Real time position validity monitoring’ sub-module, and a ‘Trajectory post processing’ sub-module, realizing different functions of the algorithm. The functioning of the individual sub-modules is explained below.

If it has been evaluated by the ‘Consolidated event status’ module that the event of a pressure of a touching object is ongoing, the ‘Feature extraction’ sub-module computes a ratio between the values A₁, A₂ of the signal amplitudes of the respective output signals of the first distance sensor 20 and the second distance sensor 30. This is done to determine the position of a pressure of a touching object of the surface of the ceiling 40 independently of the force applied by a user on the surface. It makes the assumptions that the touch position is a function of the ratio of the distance variations between the sensors 20, 30 and the light-reflective surface 80. As explained above, experiments provided by the inventors with optical force sensors verified this assumption with a good level of accuracy.

According to a possible embodiment of the algorithm, normalized ratios N of the values A₁, A₂ of the signal amplitudes are computed by the ‘Feature extraction’ sub-module, as follows:

If (since A₁>0; A₂>0) A₁>A₂:

$$N = 1 - \frac{{A}_{2}}{{A}_{1}}$$

else if (since A₁>0; A₂>0) A2>A1:

$$N = - 1 + \frac{{A}_{1}}{{A}_{2}}$$

else:

$$N = 0$$

The normalized ratio N computed by the ‘Feature extraction’ sub-module is used as input parameter for the ‘Polynomial evaluation’ sub-module. The ‘Polynomial evaluation’ sub-module uses the polynomial to determine the current position X(t) of a pressure of a touching object corresponding to the values A₁ and A₂ of the signal amplitudes. The current position X(t) of a touch-event is calculated as

$$X ( t ) = {α}_{2} * {N}^{2} + {α}_{1} * N + {α}_{0}$$

In this example, for reasons of simplification of the calculation and reduction of the computing time, a polynomial function of order 2 is used.

The ‘Real time position validity monitoring’ sub-module determines whether the values A₁, A₂ of the signal amplitudes of the first and second output signals are reliable/suitable for the position determination/estimation. In a case, where the sensor measurements of the first and second optical force sensor 20, 30 are not well synchronized, some constraints can be taken into account.

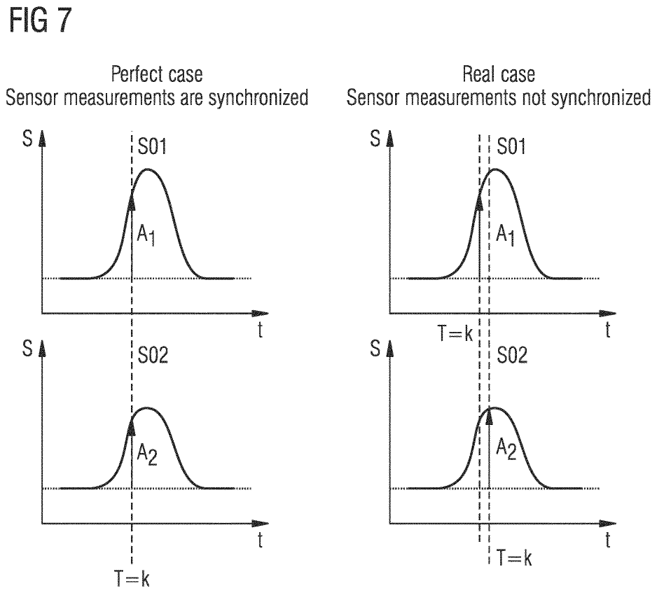

FIG. 7 illustrates the desynchronization consequence of the values A₁ and A₂ of the signal amplitudes of the output signals of the first and second distance sensors 20 and 30. FIG. 7 shows in the left half the synchronized/perfect case, whereas the right half of FIG. 7 shows the real case, where the values A₁ and A₂ of the signal amplitudes of the output signals are not measured at the same time.

As the measurements are not done at the exact same time, the computed values A₁ and A₂ of the amplitudes do not reflect the exact deflection of the ceiling 40. Consequently, the computed amplitude ratio can be wrong, especially if one of the signal derivatives D1 or D2 is large. By the ‘Real time position validity monitoring’ sub-module, a position validity flag V(t) is introduced. The flag V(t) indicates whether a signal amplitude measured at the time t, and, consequently, the position X(t) estimated by the ratio of the values A₁, A₂ of the pair of signal amplitudes including this signal amplitude is considered as valid or reliable.

The actual measured value Sᵢ of the output signal of each distance sensor i is considered as valid only if the current derivative Dᵢ of the output signal of the respective distance sensor i is below a threshold α*Aᵢ. The parameter α may be set, for example, to 0.2. By the ‘Real time position validity monitoring’ sub-module, for each optical force sensor i, the derivative Dᵢ is calculated as:

$${D}_{i} = {S}_{i} ( t ) - {S}_{i} ( t - 1 )$$

where Sᵢ(t) is the actual measured value of the output signal of sensor i at time t, and Sᵢ(t−1) is the actual measured value of the output signal of sensor i at previous time step t−1.

If for all the available optical force sensors i, the ‘Real time position validity monitoring’ sub-module determines that Dᵢ<α*Aᵢ, the measured value Ai of the signal amplitude and thus the later computed position X(t) is considered as valid, and the position validity flag V(t) is set correspondingly. Furthermore, if any of the values Aᵢ of the signal amplitudes of the first and second output signal are below a certain threshold, the position is considered as invalid.

The ‘Trajectory post processing’ sub-module allows outputting a smoothed event touch position Xₛ(t). By the ‘Trajectory post processing’ sub-module, it is checked, if the current position X(t) computed by the function is determined as being valid. If the current position of a touch event/object pressure on the ceiling 40 is determined to be valid, the last computed position X(t) is appended to an event trajectory comprising a set of previously calculated positions X(t−10), X(t−9), . . . , X(t−1). If the event trajectory size is large enough to be smoothed, trajectory smoothing is performed, for example by using a median filter and/or an average filter, to output a stable position Xₛ(t). Otherwise, if the current position X(t) computed by the function is determined as being non-valid, or the event trajectory size is not large enough for performing the smoothing process, the current computed position X(t) is output and the validity flag is set ‘NOT VALID’.

The embodiments of the touch-sensitive sensor device and the slide controller device disclosed herein have been discussed for the purpose of familiarizing the reader with novel aspects of the devices. Although preferred embodiments have been shown and described, many changes, modifications, equivalents and substitutions of the disclosed concepts may be made by one having skill in the art without unnecessarily departing from the scope of the claims.

In particular, the design of the touch-sensitive sensor device and the slide controller device is not limited to the disclosed embodiments, and gives examples of many alternatives as possible for the features included in the embodiments discussed.

Features recited in separate dependent claims may be advantageously combined.

Furthermore, as used herein, the term “comprising” does not exclude other elements. In addition, as used herein, the article “a” is intended to include one or more than one component or element, and is not limited to be construed as meaning only one.

### REFERENCES

1 touch slider sensor device
2 slide controller device
3 outer touch-sensitive surface
4 button
5 light elements for feedback
10 carrier board
20 first optical force sensor
21 first light emitter
22 first light receiver
30 second optical force sensor
31 second light emitter
32 second light receiver
40 light-reflective ceiling
41 touch-sensitive surface
50 cavity
60 processing circuit
70 housing
80 light-reflective surface

1. A touch-sensitive sensor device for sensing a position of an object touch on the sensor device, comprising:
a housing having a ceiling,
a first distance sensor and a second distance sensor disposed spaced apart from each other in the housing,
a light-reflective surface disposed spaced apart from the first and second distance sensor,
a processing circuit configured to determine the position of the object touch on the ceiling by evaluating a detected first distance variation between the first distance sensor and the light-reflective surface caused by the object touch, and a detected second distance variation between the second distance sensor and the light-reflective surface caused by the object touch, wherein the detected first distance variation is based on a measurement of the first distance sensor and the detected second distance variation is based on a measurement of the second distance sensor.

2. The touch-sensitive sensor device of claim 1,
wherein the first distance sensor is configured to generate a first output signal, wherein a value of a signal amplitude of the first output signal represents the first distance variation,
wherein the second distance sensor is configured to generate a second output signal, wherein a value of a signal amplitude of the second output signal represents the second distance variation.

3. The touch-sensitive sensor device of claim 1,
wherein the ceiling is configured as the light-reflective surface.

4. The touch-sensitive sensor device of claim 1, comprising:
a ground floor disposed spaced apart from the first and second distance sensor,
wherein the ground floor comprises the light-reflective surface.

5. The touch-sensitive sensor device of claim 1,
wherein the first distance sensor comprises a first optical force sensor that comprises a first light emitter and a first light receiver,
wherein the second distance sensor comprises a second optical force sensor that comprises a second light emitter and a second light receiver.

6. The touch-sensitive sensor device of claim 5,
wherein the first light emitter is configured to emit first light beams towards the light-reflective surface,
wherein the second light emitter is configured to emit second light beams towards the light-reflective surface,
wherein the light-reflective surface is configured to reflect a portion of the first light beams towards the first light receiver,
wherein the light-reflective surface is configured to reflect a portion of the second light beams towards the second light receiver.

7. The touch-sensitive sensor device of claim 5,
wherein the first light receiver is configured to provide a first output signal in dependence on an intensity of the portion of the first light beams received by the first light receiver,
wherein the second light receiver is configured to provide a second output signal in dependence on an intensity of the portion of the second light beams received by the second light receiver.

8. The touch-sensitive sensor device of claim 1,
wherein the ceiling has an area being flexible such that the distance between the first and second distance sensor and the light-reflective surface is changed by applying a pressure onto the area.

9. The touch-sensitive sensor device of claim 1,
wherein the ceiling has an area having a flat surface or a curved surface.

10. The touch-sensitive sensor device of claim 1,
wherein the ceiling has a material being opaque for a respective wavelength of the light the first and second light receivers are sensitive to receive.

11. The touch-sensitive sensor device of claim 5,
wherein the first light emitter is configured to emit the first light beams with a first wavelength,
wherein the second light emitter is configured to emit the second light beams with a second wavelength being different from the first wavelength.

12. The touch-sensitive sensor device of claim 2,
wherein the processing circuit is configured to determine the position of the object touch on the ceiling in dependence from the value of the signal amplitude of the first output signal and the value of the signal amplitude of the second output signal.

13. The touch-sensitive sensor device of claim 1,
wherein the processing circuit is configured to determine a smoothed position by applying median and/or average filtering to a plurality of positions determined at subsequent times.

14. The touch-sensitive sensor device of claim 1,
wherein the processing circuit is configured to assess the position of the object touch on the ceiling as being valid by calculating a derivative of the first and second output signal and evaluating the derivative with respect to a threshold value.

15. A slide controller device for controlling an apparatus, comprising:
a touch-sensitive sensor device configured to sense a position of an object touch on the sensor device, comprising:
a housing having a ceiling,
a first distance sensor and a second distance sensor disposed spaced apart from each other in the housing,
a light-reflective surface disposed spaced apart from the first and second distance sensor,
a processing circuit configured to determine the position of the object touch on the ceiling by evaluating a detected first distance variation between the first distance sensor and the light-reflective surface caused by the object touch, and a detected second distance variation between the second distance sensor and the light-reflective surface caused by the object touch, wherein the detected first distance variation is based on a measurement of the first distance sensor and the detected second distance variation is based on a measurement of the second distance sensor,
wherein the slide controller device has an outer surface, said outer surface comprising the ceiling of the touch-sensitive sensor device, or being mechanically coupled to the ceiling of the touch-sensitive sensor device so that a distance between the light-reflective surface and the first and second distance sensor is changed, while applying a force onto the outer surface of the controller device.

16. The slide controller device as claimed in claim 15,
wherein the first distance sensor is configured to generate a first output signal, wherein a value of a signal amplitude of the first output signal represents the first distance variation,
wherein the second distance sensor is configured to generate a second output signal, wherein a value of a signal amplitude of the second output signal represents the second distance variation.

17. The slide controller device as claimed in claim 15, wherein the ceiling is configured as the light-reflective surface.

18. The slide controller device as claimed in claim 15, comprising:
a ground floor disposed spaced apart from the first and second distance sensor,
wherein the ground floor comprises the light-reflective surface.

19. The slide controller device as claimed in claim 15,
wherein the first distance sensor comprises a first optical force sensor that comprises a first light emitter and a first light receiver,
wherein the second distance sensor comprises a second optical force sensor that comprises a second light emitter and a second light receiver.

20. The slide controller device as claimed in claim 19,
wherein the first light emitter is configured to emit first light beams towards the light-reflective surface,
wherein the second light emitter is configured to emit second light beams towards the light-reflective surface,
wherein the light-reflective surface is configured to reflect a portion of the first light beams towards the first light receiver,
wherein the light-reflective surface is configured to reflect a portion of the second light beams towards the second light receiver,
wherein the first light receiver is configured to provide a first output signal in dependence on an intensity of the portion of the first light beams received by the first light receiver,
wherein the second light receiver is configured to provide a second output signal in dependence on an intensity of the portion of the second light beams received by the second light receiver.
